(19) United States
(12) Patent Application Publication
(10) Pub. No.: US 2013/0243249 A1
(43) Pub. Date: Sep. 19, 2013

(54) ELECTRONIC DEVICE AND METHOD FOR RECOGNIZING IMAGE AND SEARCHING FOR CONCERNING INFORMATION

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: QIANG YOU, Shenzhen (CN)

(73) Assignees: HON HAI PRECISION INDUSTRY CO., LTD., New Taipei (TW); Fu Tai Hua Industry (Shenzhen) Co., Ltd., Shenzhen (CN)

(21) Appl. No.: 13/798,196

(22) Filed: Mar. 13, 2013

(30) Foreign Application Priority Data
Mar. 19, 2012 (CN) 201210072027.2

(51) Int. Cl. G06K 9/62

(52) U.S. Cl. CPC G06K 9/6202
USPC 382/103

(57) ABSTRACT

A method for recognizing an image of an object and searching for concerning information is provided. The method includes: capturing an image of an object; analyzing the image to extract characteristic from the image, and generating a request for searching for further information associated with the image; searching for further information associated with the image from a searchable database according to the request and the extracted characteristic of the image; and displaying all of the information which has been found. A related electronic device is also provided.

### BACKGROUND

1. Technical Field

The present disclosure relates to systems for processing images, and particularly to an electronic device and a method for recognizing an image and searching for concerning information.

2. Description of Related Art

People can take out their smart phones to photograph pictures or access internet to search for information. However, people need to input key words to search for what they want, which consumes a lot of time and is an inconvenience. For example, when people see a strange building by chance, they may be interested in the building and want to have detail information, such as the architectural style of the building, and other related information. People can photograph the building, but it is difficult for people to search for the detail information about a strange building if the building itself is new to them.

Therefore, an electronic device and a method for recognizing an image and searching for concerning information are needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an electronic device for recognizing an image and searching for concerning information, according to an embodiment.

FIG. 2 is a block diagram of a searchable database of the electronic device of FIG. 1.

FIG. 3 is another block diagram of the electronic device of FIG. 1, according to another embodiment.

FIG. 4 is a flowchart illustrating a method for recognizing an image and searching for concerning information.

### DETAILED DESCRIPTION

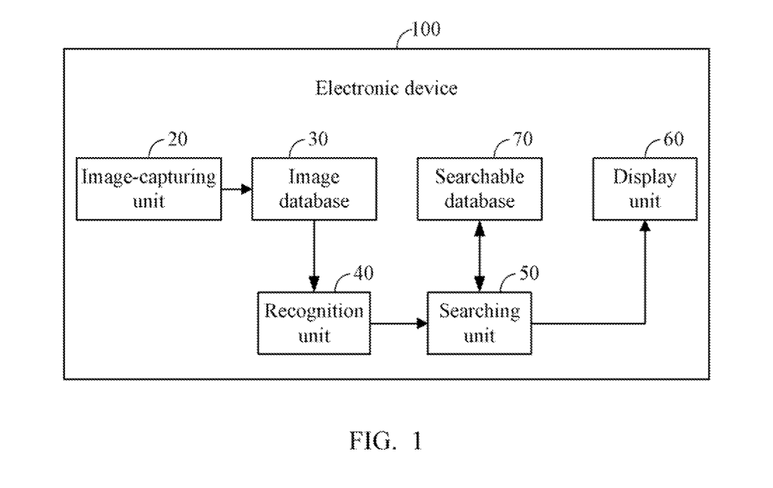

Referring to FIG. 1, an electronic device 100 for recognizing an image of an object and searching for concerning information is illustrated. The electronic device 100 includes an image-capturing unit 20, an image database 30, a recognition unit 40, a searching unit 50 and a display unit 60. In the embodiment, the electronic device 100 includes, but is not limited to being, a smart phone, for example.

The image-capturing unit 20 is configured to capture an image of an object, and store the image in the image database 30. The recognition unit 40 is configured to analyze a selected image, to extract characteristic from the selected image, and generate a request for searching for further information associated with the selected image.

The searching unit 50 is configured to search for further information associated with the selected image from a searchable database 70 according to the request and the extracted characteristic of the selected image.

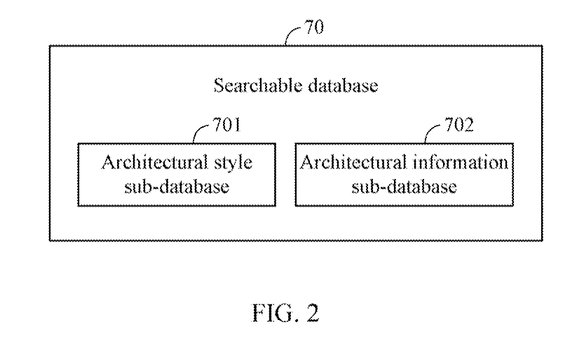

Referring to FIG. 2, in the embodiment, the searchable database 70 includes an architectural style sub-database 701 and an architectural information sub-database 702. The architectural style sub-database 701 pre-stores many images of buildings of a variety of architectural styles, such as French Classical style, Gothic style, and others. The architectural information sub-database 702 pre-stores detail information associated with each architectural style of buildings, such as the origin, the development history, typical representative works, and further information.

In the embodiment, the searching unit 50 searches for pre-stored images having characteristics similar to the extracted characteristic of the selected image within the architectural style sub-database 701, so as to determine the architectural style of the selected image.

The searching unit 50 further searches for detail information associated with the determined architectural style within the architectural information sub-database 702.

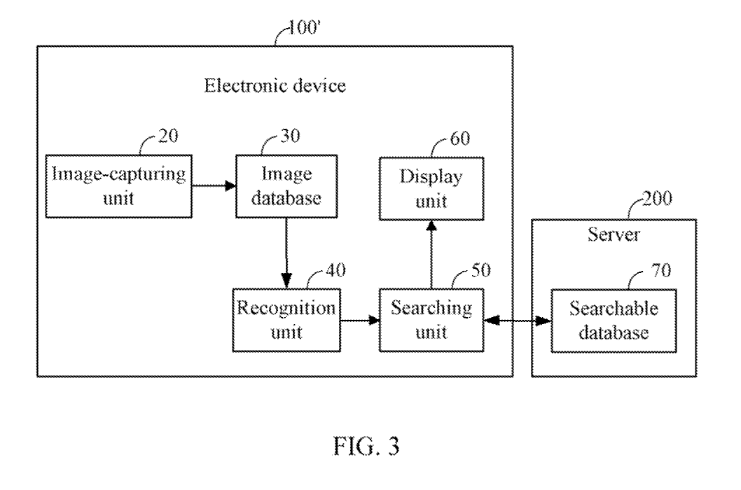

In one embodiment, the searchable database 70 is stored in the electronic device 100. In an alternative embodiment, referring to FIG. 3, the searchable database 70 is stored in a network server 200, and the searching unit 50 of the electronic device 100′ accesses the searchable database 70 via a network.

The display unit 60 is configured to display search result of the searching unit 50.

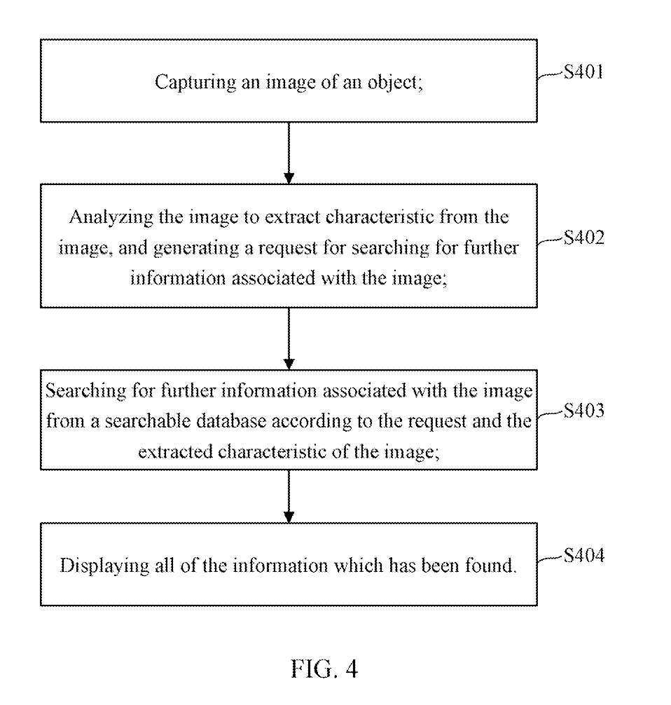

FIG. 4 is a flowchart illustrating a method for recognizing an image of an object and searching for concerning information:

In step S401, the image-capturing unit 20 captures an image of an object. In the embodiment, the object is a building.

In step S402, the recognition unit 40 analyzes the image to extract characteristic from the image, and generates a request for searching for further information associated with the image.

In step S403, the searching unit 50 searches for further information associated with the image from a searchable database 70 according to the request and the extracted characteristic of the image.

In the embodiment, the searching unit 50 searches for pre-stored images which have characteristics similar to the extracted characteristic of the image within the architectural style sub-database 701, so as to determine the architectural style of the image. The searching unit 50 further searches for detail information associated with the determined architectural style within the architectural information sub-database 702.

In step S404, the display unit 60 displays all of the information found by the searching unit 50.

This disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electronic device comprising:
an image-capturing unit configured to capture an image of an object;
a recognition unit configured to analyze the image, to extract characteristic from the image, and generate a request for searching for further information associated with the image;
a searching unit configured to search for further information associated with the image from a searchable database according to the request and the extracted characteristic of the image; and
a display unit configured to display search result of the searching unit.

2. The electronic device as described in claim 1, further comprising the searchable database.

3. The electronic device as described in claim 2, wherein the object is a building, the searchable database comprises an architectural style sub-database, the architectural style sub-database pre-stores a plurality of images of buildings of a variety of architectural styles, and the searching unit is configured to search for pre-stored images having characteristics similar to the extracted characteristic of the image within the architectural style sub-database, so as to determine the architectural style of the image.

4. The electronic device as described in claim 3, wherein the searchable database further comprises an architectural information sub-database, the architectural information sub-database pre-stores detail information associated with each architectural style of buildings, and the searching unit is further configured to search for detail information associated with the determined architectural style within the architectural information sub-database.

5. A method for recognizing an image of an object and searching for concerning information, the method comprising:
capturing an image of an object;
analyzing the image to extract characteristic from the image, and generating a request for searching for further information associated with the image;
searching for further information associated with the image from a searchable database according to the request and the extracted characteristic of the image; and
displaying all of the information which has been found.

6. The method as described in claim 5, wherein the object is a building, the searchable database comprises an architectural style sub-database and an architectural information sub-database, the architectural style sub-database pre-stores a plurality of images of buildings of a variety of architectural styles, and the architectural information sub-database pre-stores detail information associated with each architectural style of buildings.

7. The method as described in claim 6, wherein the step of searching for further information associated with the image from a searchable database comprises:
searching for pre-stored images which have characteristics similar to the extracted characteristic of the image within the architectural style sub-database,;
determining the architectural style of the image; and
searching for detail information associated with the determined architectural style within the architectural information sub-database.
